(19) United States
(12) Patent Application Publication
(10) Pub. No.: US 2012/0326669 A1
(43) Pub. Date: Dec. 27, 2012

(54) POWER TOOL STORAGE CASE

(75) Inventors: Toru HORIYAMA, Anjo-shi (JP); Atsushi KANOU, Anjo-shi (JP); Shusaku WAKATSUKI, Anjo-shi (JP); Shinya BITO, Anjo-shi (JP)

(73) Assignee: MAKITA CORPORATION, Anjo-shi (JP)

(21) Appl. No.: 13/478,425

(22) Filed: May 23, 2012

(30) Foreign Application Priority Data
Jun. 27, 2011 (JP) 2011-142014

(51) Int. Cl. H02J 7/00

(52) U.S. Cl. 320/113

(57) ABSTRACT

A power tool storage case includes a main case that has a tool storage portion, a battery storage portion and a charger storage portion, and a lid that can open and close the main case. The charger storage portion is a dual-purpose storage portion that can hold one of a charger and a battery pack in accordance with selection of one of the charger and the battery pack.

### BACKGROUND OF THE INVENTION

This application claims the benefit of Japanese Patent Application Number 2011-142014 filed on Jun. 27, 2011, the entirety of which is incorporated by reference.

### TECHNICAL FIELD

The present invention relates to a power tool storage case that is used to store a rechargeable power tool, such as an impact driver or the like, and accessories of the rechargeable power tool.

### BACKGROUND ART

Power tool storage cases are known for rechargeable power tools, such as an impact driver etc., in which accessories, such as replacement bits (tool tips), a battery pack that is used as a power source, a charger for the battery pack and so on, are stored together with the power tool main body. The power tool and its accessories can thus be carried and stored at the same time. Such a power tool storage case is disclosed in Japanese Patent Application Publication No. JP 2006-205323 A, in which a plurality of ribs are provided in a standing manner inside a square box shaped storage case, thus partitioning the storage case into a tool storage portion to store the power tool main body, a battery storage portion to store a backup battery pack, a charger storage portion to store a charger, and so on.

However, at an actual work site, it is sometimes necessary to carry an extra backup battery pack to work in place of the charger, rather than carrying the power tool main body, the backup battery pack and the charger together as a set. Therefore, with the above-described known power tool storage case, the backup battery pack is stored and carried in the charger storage portion, in place of the charger. In this case, as the battery packs are stored in a space that is larger than the battery pack, it is easy for the battery packs to move around while being carried and there is a risk of battery packs colliding with each other and being damaged.

### SUMMARY OF THE INVENTION

In light of the above, the present invention provides a power tool storage case providing excellent usability that can hold a backup battery pack in a stable manner without any wobble, in what is originally a charger storage portion.

A first aspect of the invention provides a power tool storage case including a main case having a plurality of storage portions that can respectively store a rechargeable power tool, a battery pack that is a power source of the rechargeable power tool, and a charger that can charge the battery pack, and a lid that can open and close the main case. The charger storage portion storing the charger is a dual purpose storage portion that can hold one of the charger and the battery pack in accordance with selection of one of the charger and the battery pack.

A second aspect of the invention is structured such that, in the configuration of the first aspect, the charger storage portion can hold a plurality of the battery packs.

A third aspect of the invention is structured such that, in the configuration of the first aspect, a battery retaining portion, which conforms to an outer shape of the battery pack, is formed as a recess in a bottom surface of the charger storage portion, such that one of the charger and the battery pack can be held.

A fourth aspect of the invention is structured such that, in the configuration of the first aspect, retaining members that form a battery retaining portion that can hold the battery pack are detachably installed in the charger storage portion, and one of the charger and the battery pack can be held by selecting installation or removal of the retaining members.

A fifth aspect of the invention is structured such that, in the configuration of the fourth aspect, the retaining members are plate members that are provided in a standing manner on a bottom surface of the main case to form the battery retaining portion in a curing manner and that have upper edges along a whole length of which fold-back portions for reinforcement are formed in a curving manner.

A sixth aspect of the invention includes, in the configuration of the first aspect, a presser portion that is formed on an underneath surface of the lid such that, when the main case is in a closed state, the presser portion comes into contact with the battery pack that is held in the charger storage portion.

According to the first aspect of the invention, the original charger storage portion has excellent ease of use and can hold a backup battery pack in a stable manner without the battery pack moving around.

According to the second aspect of the invention, in addition to the benefits of the first aspect, it is possible to hold a sufficient number of the backup battery packs, thus further improving usability.

According to the third aspect of the invention, in addition to the benefits of the first aspect, it is possible to hold one of the charger and the battery pack in accordance with selection of one of the charger and the battery pack, without providing another member.

According to the fourth aspect of the invention, in addition to the benefits of the first aspect, it is possible to select whether to hold one of the charger and the battery pack by a simple operation of installing and removing the retaining members.

According to the fifth aspect of the invention, in addition to the benefits of the fourth aspect, it is possible to secure the rigidity of the plate members and thus to enhance the stability of the battery pack when the battery pack is held in the charger storage portion.

According to the sixth aspect of the invention, in addition to the benefits of the first aspect, it is possible to hold the battery pack more reliably.

### BRIEF DESCRIPTION OF THE DRAWINGS

FIG. 1 is a perspective view of a power tool storage case according to a first embodiment when a charger is stored.

FIG. 2 is a plan view of the power tool storage case according to the first embodiment when the charger is stored.

FIG. 3 is a perspective view of the power tool storage case according to the first embodiment when battery packs are stored.

FIG. 4 is a plan view of the power tool storage case according to the first embodiment when the battery packs are stored.

FIG. 5 is a sectional view taken along a line A-A of FIG. 4.

FIG. 6 is a perspective view of the power tool storage case in which a small parts storage portion is provided.

FIG. 7 is a plan view of the power tool storage case in which the small parts storage portion is provided.

FIG. 8 is a perspective view of a power tool storage case according to a second embodiment when a charger is stored.

FIG. 9 is a plan view of the power tool storage case according to the second embodiment when the charger is stored.

FIG. 10 is a perspective view of the power tool storage case according to the second embodiment when battery packs are stored.

FIG. 11 is a plan view of the power tool storage case according to the second embodiment when the battery packs are stored.

FIG. 12 is a perspective view of the power tool storage case in which a box is provided.

FIG. 13 is a plan view of the power tool storage case in which the box is provided.

### DETAILED DESCRIPTION OF THE EMBODIMENTS

Hereinafter, embodiments of the present invention will be explained with reference to the figures.

### First Embodiment

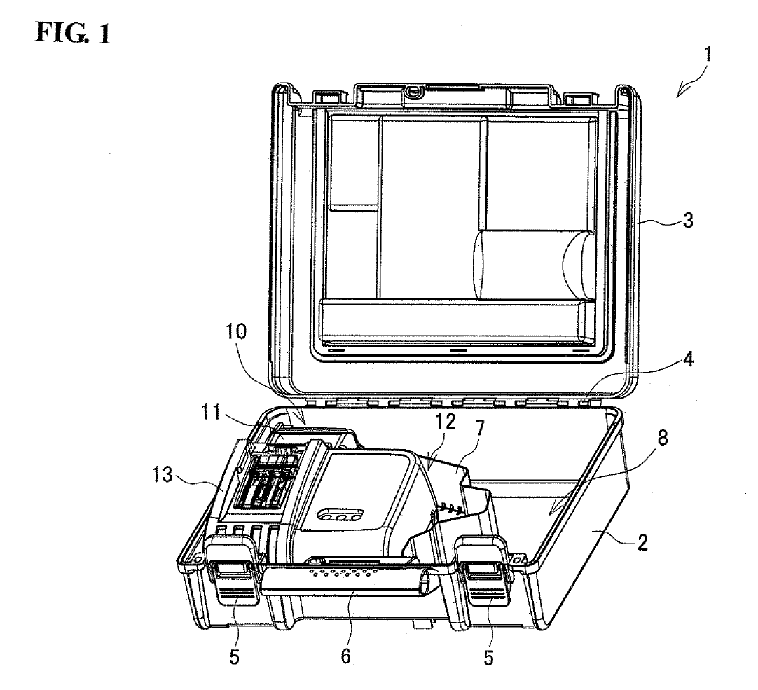

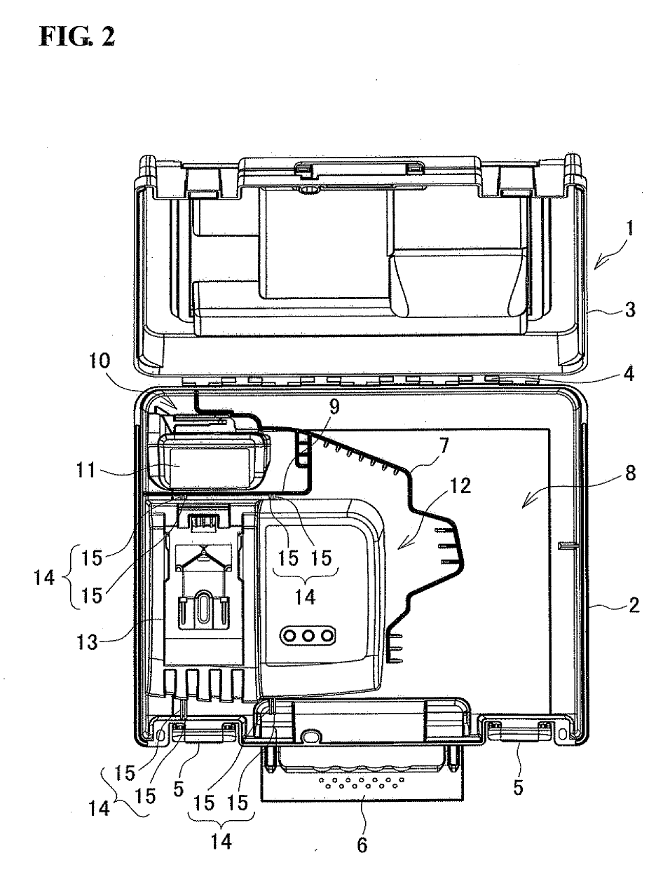

FIG. 1 and FIG. 2 show one example of a power tool storage case (hereinafter simply referred to as a “storage case”). A storage case 1 is made of synthetic resin and includes a deep, square box shaped main case 2 and a shallow lid 3 that has the same square box shape as the main case 2. Each of the main case 2 and the lid 3 are injection molded. The main case 2 and the lid 3 are hinge jointed such that an opening on an upper side of the main case 2 and an opening on a lower side of the lid 3 are aligned with each other in a closed state and opening edges on a rear surface (when the lower left side in FIG. 1 (the lower side in FIG. 2) is a frontward direction) can be rotated with respect to each other by a shaft 4.

Further, opening edges of the main case 2 and the lid 3 on a front side can be mutually locked and unlocked using a pair of left and right latches 5, and a handle 6 is provided on a front surface of the main case 2 between both the latches 5.

In addition, a first partition panel 7 is provided in a standing manner on a bottom surface of the main case 2, extending while curving in a forward direction from a position to the left of a center of a rear wall. To the right side of the first partition panel 7, a power tool storage portion 8, in which a rechargeable power tool such as an impact driver or a driver drill (not shown in the figures) can be stored, is partitioned and formed. Furthermore, a second partition panel 9, which has a slanted L shape in a plan view, is provided in a standing manner in a rear left corner portion of the main case 2. A battery storage portion 10, in which a backup battery pack 11 can be stored, is formed between the second partition panel 9 and the first partition panel 7. A charger storage portion 12, in which a charger 13 can be stored, is formed to the front of the second partition panel 9 and to the left side of the first partition panel 7. The charger 13 has a rectangular shape in a plan view and is used to charge the battery pack 11. When the charger 13 is stored in the charger storage portion 12, a front surface and a back surface of the charger 13 come into contact, respectively, with a front wall of the main case 2 and with the second partition panel 9, and movement of the charger 13 in the front-rear direction is thus regulated. A left side surface of the charger 13 comes into contact with a left wall of the main case 2 and a right side surface of the charger 13 comes into contact with the first partition panel 7, respectively, and movement of the charger 13 in the left-right direction is thus regulated.

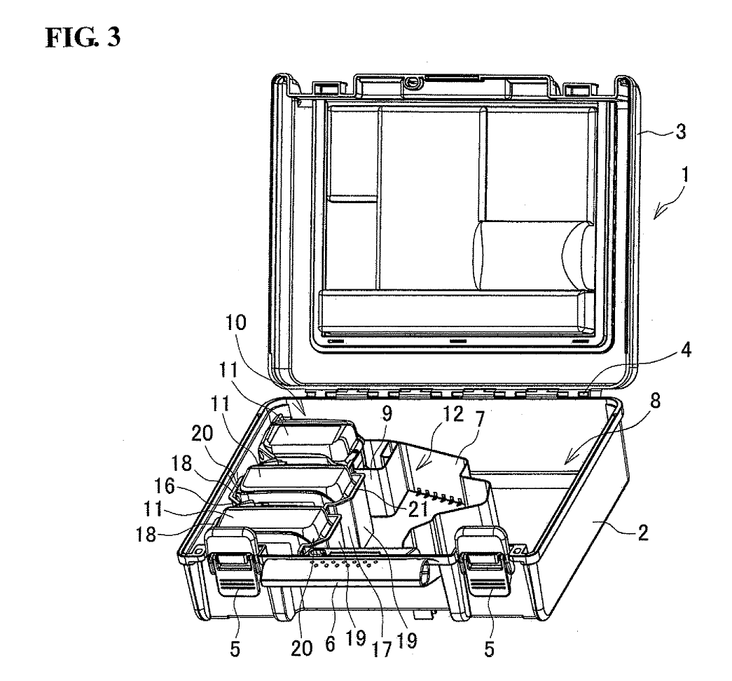

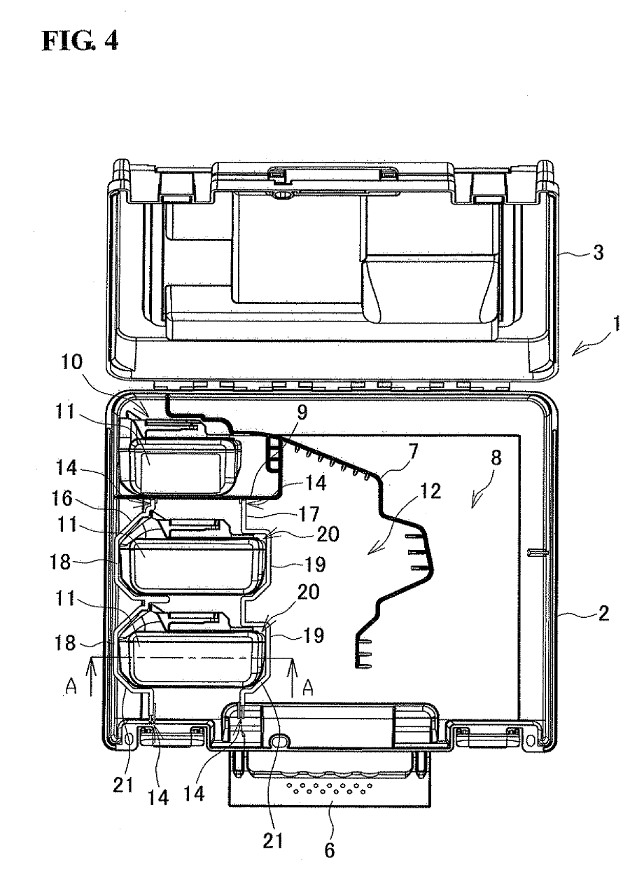

Then, in the charger storage portion 12, insertion portions 14 are formed in a surface of the front wall of the main case 2 facing the second partition panel 9 and a surface of the second partition panel 9 facing the front wall. The insertion portions 14 are each formed of a pair of protrusions 15 which are slightly separated from each other in the left-right direction and which protrude in the up-down direction. The insertion portions 14 are provided as respective pairs in the left-right direction and also such that they oppose each other in the front-rear direction. In a state in which the charger 13 is removed, a pair of retaining plates 16 and 17 can respectively be installed, as retaining members, between each pair of the front and rear insertion portions 14, as shown in FIG. 3 and in FIG. 4.

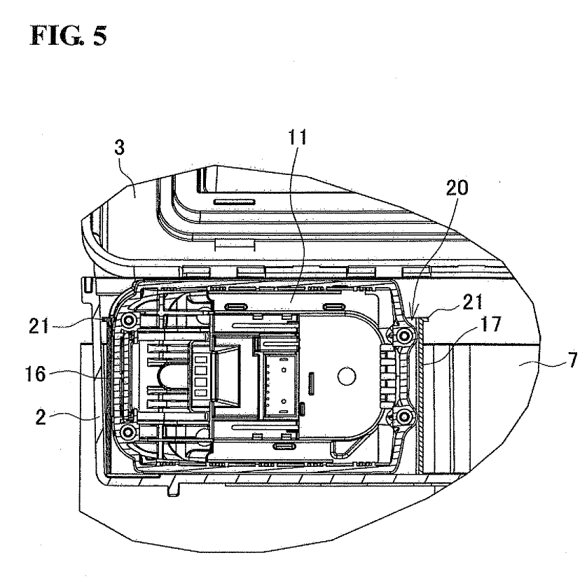

A height of the retaining plates 16 and 17 is greater than that of the first partition panel 7 and the second partition panel 9. The retaining plate 16 is formed of two curved rear fitting portions 18 that fit with a rear end of the battery pack 11 when the battery pack 11 is placed laterally. Meanwhile, the retaining plate 17 is formed of two curved front fitting portions 19 that fit with a front end of the battery pack 11. By inserting the ends of the retaining plates 16 and 17, from above, between the protrusions 15 of the front and rear insertion portions 14 respectively, two battery retaining portions 20 are formed in the charger storage portion 12. It should be noted that, as shown in FIG. 5, fold-back portions 21 for reinforcement are formed curving to an outer side along a whole length, in the longitudinal direction, of upper edges of each of the retaining plates 16 and 17, thus enhancing rigidity in a direction orthogonal to plate surfaces.

With the storage case 1 that is configured as described above, when the charger 13 needs to be carried in addition to the rechargeable power tool and the backup battery pack 11, it is sufficient to hold the charger 13 in the charger storage portion 12 as it is, without using the retaining plates 16 and 17, as shown in FIG. 1 and FIG. 2. It should be noted that the unused retaining plates 16 and 17 can be stored inside the storage case 1 using spare space inside the charger storage portion 12 or inside the main case 2.

On the other hand, when the backup battery pack 11 needs to be carried in place of the charger 13, as shown in FIG. 3 and FIG. 4, the pair of retaining plates 16 and 17 may be respectively installed between each pair of the front and rear insertion portions 14, and two of the battery packs 11 may each be fitted into the battery retaining portions 20 formed inside the charger storage portion 12. In this way, a total of three of the battery packs 11 can be carried at the same time. When fitted in this way, each of the battery packs 11 are held in a state in which movement in the front-rear direction and in the left-right direction is regulated by the left and right retaining plates 16 and 17, and when the storage case 1 is carried, there is no risk that the battery packs 11 will move around.

In this way, according to the storage case 1 of the above-described embodiment, the charger storage portion 12 that can store the charger 13 is designed as a dual purpose storage portion, which can hold either the charger 13 or the battery pack 11 when either one is selected. The original charger storage portion 12 can therefore hold the backup battery packs 11 in a stable manner without the backup battery packs 11 moving around, thus providing excellent usability.

In particular, it is possible to store the two battery packs 11 in the charger storage portion 12, and a sufficient number of the backup battery packs 11 can thus be available, resulting in a further improvement in usability.

Furthermore, the retaining members (the retaining plates 16 and 17), which form the battery retaining portion 20 in which the battery pack 11 can be stored, are detachably provided in the charger storage portion 12. By selecting whether to insert or remove the retaining members, either the charger 13 or the battery pack 11 can be held. As a result, it is possible to select whether to hold the charger 13 or the battery pack 11 with a simple operation of inserting and removing the retaining members.

In addition, the retaining members are provided as the retaining plates 16 and 17 which are configured in a standing manner on the bottom surface of the main case 2 to form the battery retaining portion 20 in a curving manner. The retaining plates 16 and 17 have upper edges along a whole length of which the fold-back portions 21 for reinforcement are configured in a curving manner. As a result, it is possible to secure the rigidity of the retaining plates 16 and 17. Thus, the stability of the battery pack 11 is enhanced when the battery pack 11 is held in the charger storage portion 12.

It should be noted that, in the first embodiment, the number of battery packs that can be stored in the charger storage portion and the arrangement format of the battery packs can be modified as appropriate, and it is possible to increase or decrease the number of battery packs, and to change the storage arrangement by changing the number and shape of the fitting portions into which the retaining plates are installed. The retaining plates can also be installed in the left-right direction.

Moreover, the retaining plates are also not limited to the above-described first embodiment and the attachment structure of the retaining plates to the main case need not necessarily be insertion between the protrusions. Insertion tabs can be provided on the end portions of the retaining plates and can be inserted into through holes or recessed portions provided in the inside surface of the main case or in the partition panels. In addition, presser portions can be provided on an underneath surface of the lid such that the presser portions come into contact with the battery pack that is held in the charger storage portion.

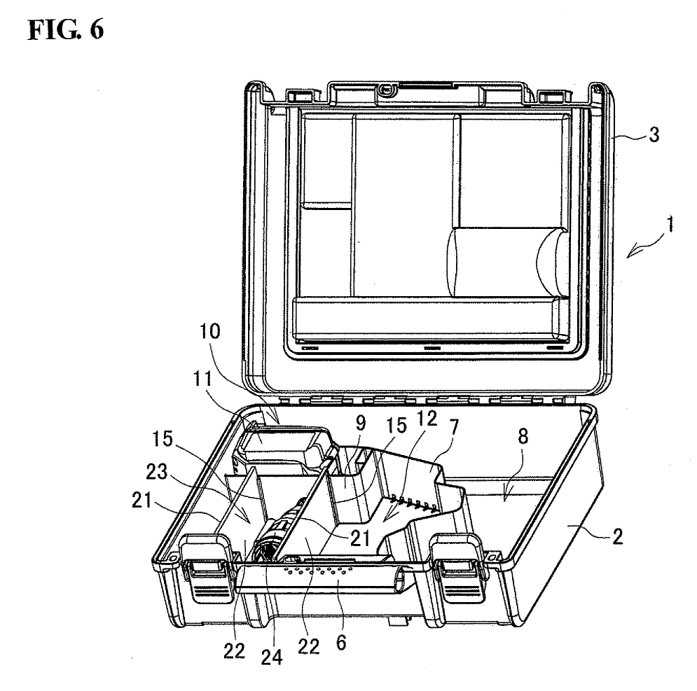

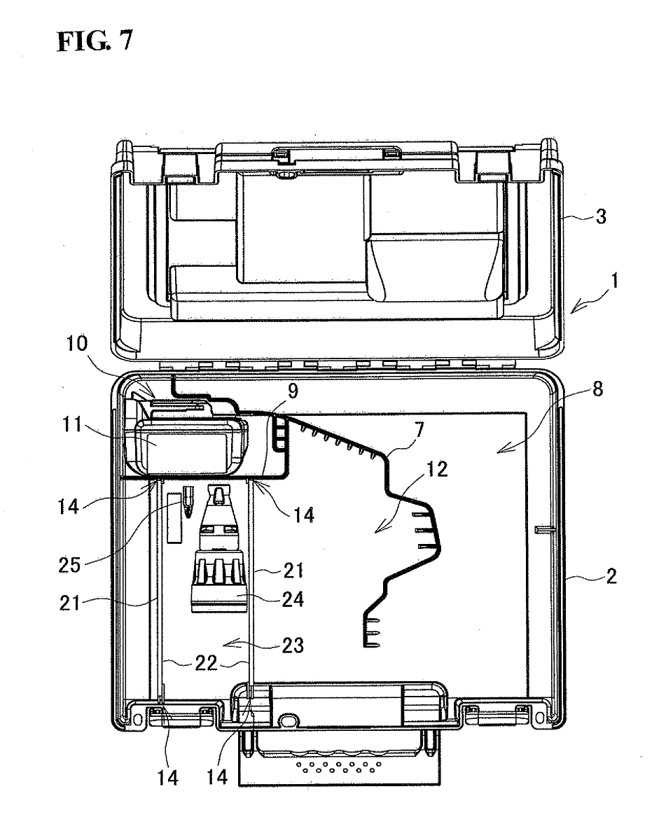

On the other hand, third partition panels 22, which are flat plates not curved, are provided as shown in FIG. 6 and FIG. 7. End portions of the third partition panels 22 are inserted from above between the front and rear insertion portions 14 vertically so that a small parts storage portion 23 for a replacement chuck 24 or a replacement bit 25 and so on can be formed. Thus, small parts, such as a replacement chuck and so on, can be carried to the worksite in place of the charger 13 or the battery pack 11.

However, even with the format shown in FIG. 3 and in FIG. 4, when the retaining plates 16 and 17 are moved to the right side by changing of the positions of the insertion portions 14, it is possible to use a space between the retaining plate 16 and the left wall of the main case 2 as the small parts storage portion. Further, when the third partition panels 22 are arranged on an outer side of the retaining plates 16 and 17, the battery retaining portion 20 and the small parts storage portion can be retained side by side. Of course, storage of small parts is also possible between both of the retaining plates 16 and 17 when the retaining plates 16 and 17 are installed, and it is thus possible to use part or all of the battery retaining portion 20 as the small parts storage portion without storing the battery pack 11.

### Second Embodiment

Next, another embodiment of the present invention will be explained. It should be noted that, where structural portions are the same as those of the first embodiment, the same reference numerals are assigned and an explanation is omitted.

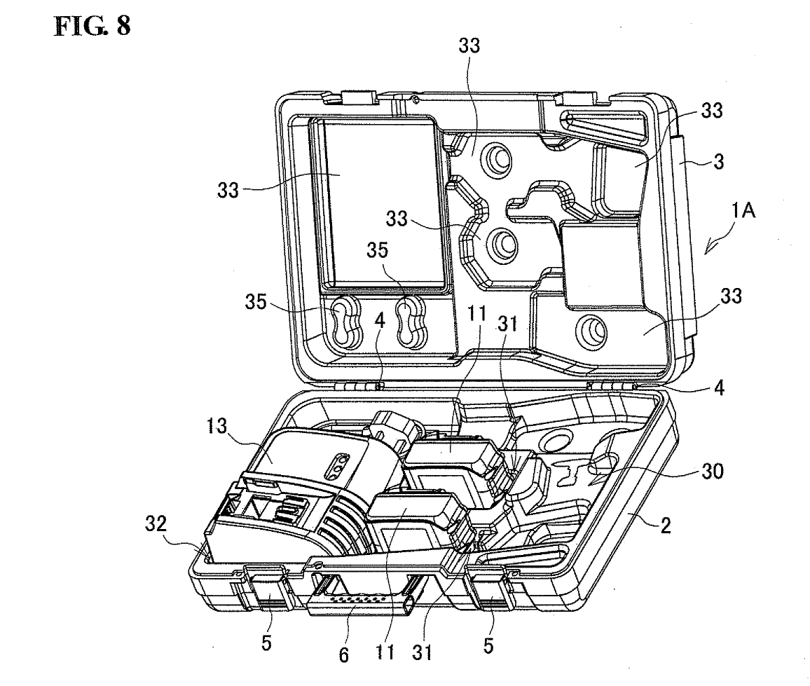

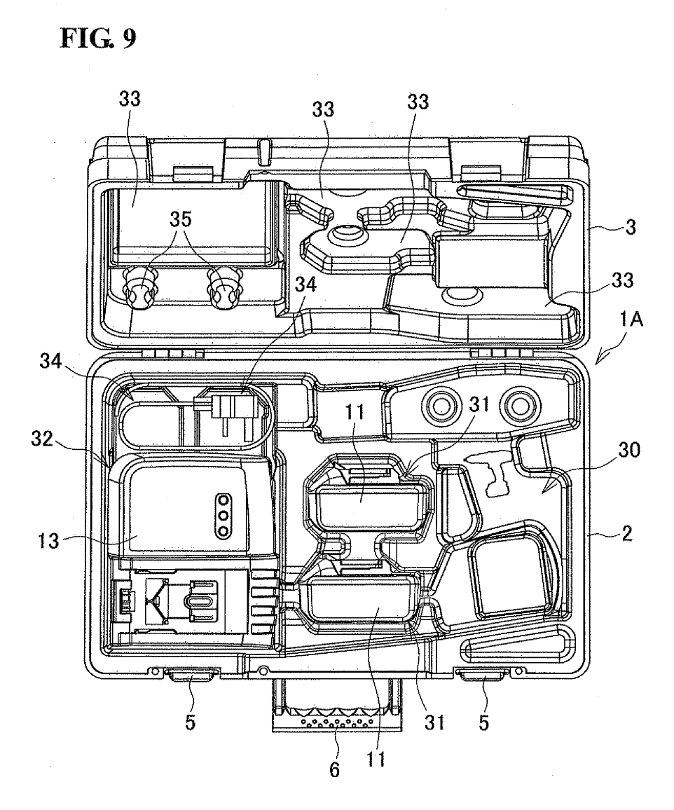

In a storage case 1A shown in FIG. 8 and FIG. 9, the main case 2 and the lid 3 are formed by so-called blow molding, and a tool storage portion 30 is formed in the bottom surface of the main case 2 on the right side. The tool storage portion 30 is recessed to conform to an outer shape of a rechargeable power tool. Further, in the center of the main case 2 and to the left side of the tool storage portion 30, two battery storage portions 31 are formed and are recessed to conform to an outer shape of the battery pack 11. In addition, on the left side of the main case 2, a charger storage portion 32 is formed and is recessed to conform to an outer shape of the charger 13.

Meanwhile, upper recesses 33 are also formed in the underneath surface of the lid 3. Each of the upper recesses 33 is formed in a position corresponding to each of the storage portions when the main case 2 is in a closed state, and each of the upper recesses 33 is recessed to conform to the outer shape of the rechargeable power tool, the battery pack 11 or the charger 13.

Then, two battery retaining portions 34 are formed side by side in the left-right direction in the bottom surface of the charger storage portion 32. The battery retaining portions 34 are recessed to conform to the outer shape of the battery pack 11 when placed laterally. Meanwhile, a pair of presser protrusions 35 are protrudingly provided in the underneath surface of the lid 3 in positions corresponding to the battery retaining portions 34. The presser protrusions 35 come into contact, respectively, with upper surfaces of the battery packs 11 that are fitted into the battery retaining portions 34. Specifically, in a state in which the charger 13 is not stored in the charger storage portion 32, the battery packs 11 can each be held by the battery retaining portions 34 and the presser protrusions 35.

With the storage case 1A structured as described above, when the charger 13 needs to be carried in addition to the rechargeable power tool and the backup battery pack 11, the charger 13 may be held inside the charger storage portion 32 as it is, as shown in FIG. 8 and FIG. 9.

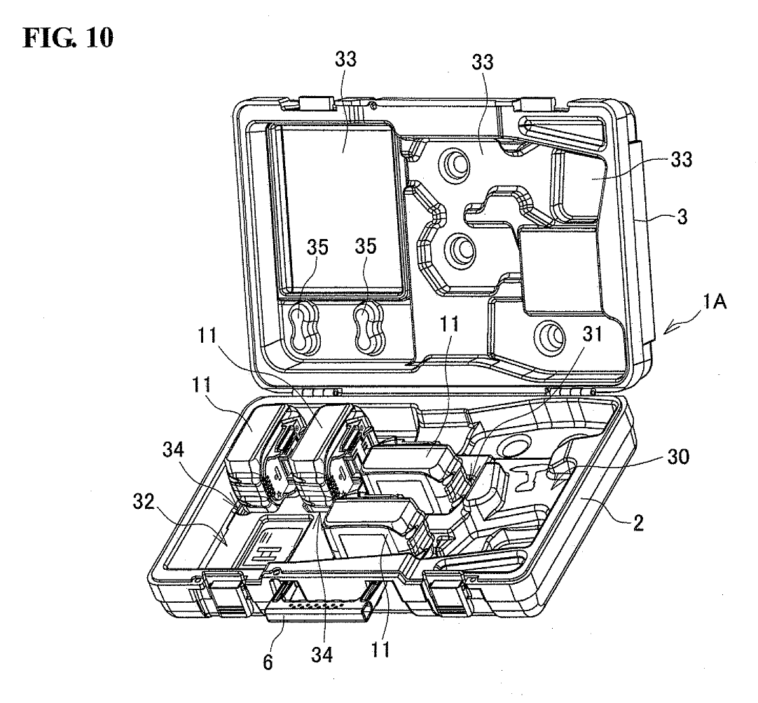

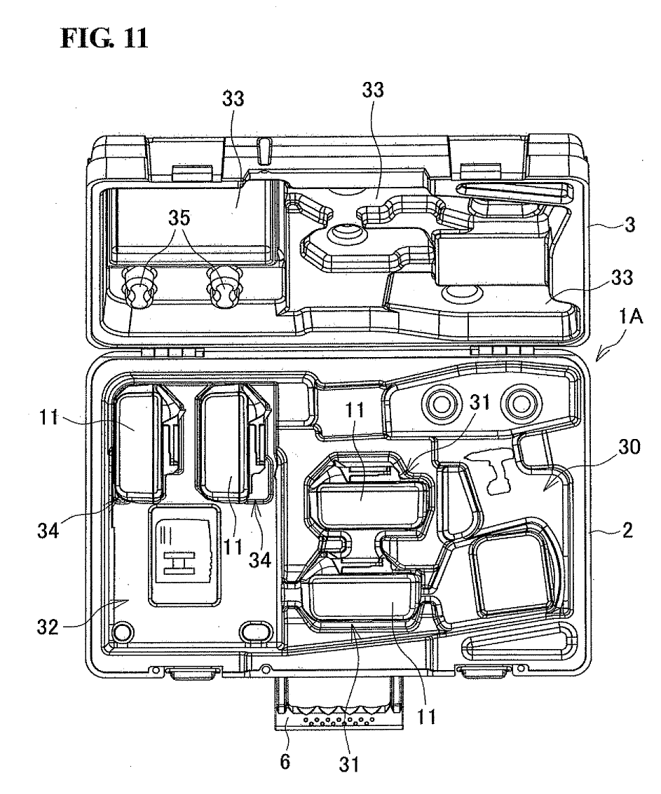

On the other hand, when the backup battery pack 11 needs to be carried in place of the charger 13, the battery packs 11 may be fitted, respectively, into the two battery retaining portions 34 formed inside the charger storage portion 32, as shown in FIG. 10 and FIG. 11. In this way, a total of four of the battery packs 11 can be carried at the same time. When fitted in this way, each of the battery packs 11 is held in a state in which its movement is regulated from underneath by being fitted into the battery retaining portion 34 and from above by the presser protrusion 35. As a result, when the storage case 1A is carried, there is no risk that the battery pack 11 will move around inside the charger storage portion 32.

In this way, with the storage case 1A of the above-described second embodiment also, the charger storage portion 32 that can store the charger 13 is designed as a dual purpose storage portion, which can hold either the charger 13 or the battery pack 11 when either one is selected. The original charger storage portion 32 can therefore hold the backup battery packs 11 in a stable manner without the backup battery packs 11 moved around, thus providing excellent usability.

In particular, as the recessed battery retaining portion 34, which conforms to the outer shape of the battery pack 11, is provided in the bottom surface of the charger storage portion 32, it is possible to store either the charger 13 or the battery pack 11. As a result, it is possible to select and hold either the charger 13 or the battery pack 11 without providing another member.

Furthermore, as the presser protrusion 35, which comes into contact with the battery pack 11 that is held in the charger storage portion 32 when the main case 2 is in a closed state, are provided on the underneath surface of the lid 3, the battery pack 11 can be more reliably held.

It should be noted that, in the above-described second embodiment, the number of the battery retaining portions provided in the charger storage portion and the arrangement format of the battery retaining portions can be modified as appropriate. For example, the battery retaining portions can be modified as appropriate, by being also provided on the lower side such that four battery packs can be held, or by arranging three of the battery retaining portions side by side in the front-rear direction by arranging them laterally, or the like. Further, the presser portions can also be modified in accordance with the number and the positions of the battery retaining portions, and may be formed not as protrusions but as a table that protrudes as a whole or the like. Alternatively, the presser portions may be omitted.

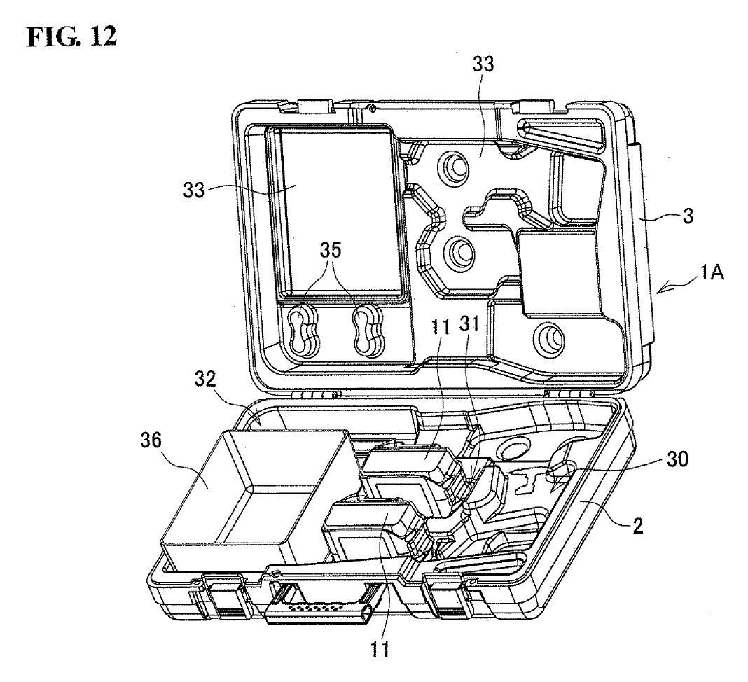

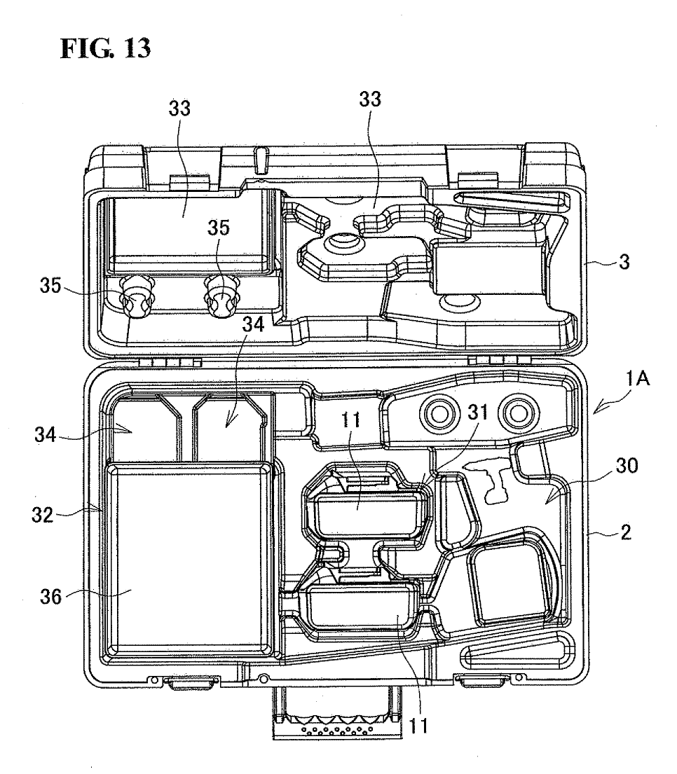

On the other hand, as shown in FIG. 12 and FIG. 13, a box 36 may be provided that fits with the charger storage portion 32 on the lower side and fits with the upper recess 33 on the upper side. When the box 36 is set inside the charger storage portion 32, the box 36 can be used as a small parts storage portion. Thus, small parts, such as a replacement chuck or the like, can be carried to the worksite in place of the charger 13 and the battery pack 11.

It should be noted that, if the box 36 is of a size that does not interfere with the battery retaining portions 34, the small parts can be stored at the same time as holding the battery packs 11.

In addition, in the case of both the first and the second embodiments, the structure of the main case and of the lid is not limited to the above-described embodiments, and the overall shape may be a different shape, such as a square or a trapezoid shape or the like. A shape of, a number of, or an arrangement of latches and handles may be modified as appropriate. Furthermore, the present invention may be applied even if the main case and the lid have a structure in which they are joined by a device other than a hinge, or have a structure in which both the main case and the lid are separate bodies.

It is explicitly stated that all features disclosed in the description and/or the claims are intended to be disclosed separately and independently from each other for the purpose of original disclosure as well as for the purpose of restricting the claimed invention independent of the composition of the features in the embodiments and/or the claims. It is explicitly stated that all value ranges or indications of groups of entities disclose every possible intermediate value or intermediate entity for the purpose of original disclosure as well as for the purpose of restricting the claimed invention, in particular as limits of value ranges.

What is claimed is:

1. A power tool storage case comprising:
a main case having a plurality of storage portions that can respectively store a rechargeable power tool, a battery pack as a power source of the rechargeable power tool, and a charger for charging the battery pack; and
a lid that can open and close the main case, wherein
a charger storage portion storing the charger is a dual purpose storage portion that can hold one of the charger and the battery pack in accordance with selection of one of the charger and the battery pack.

2. The power tool storage case according to claim 1, wherein the charger storage portion can hold a plurality of the battery packs.

3. The power tool storage case according to claim 1, wherein a battery retaining portion, which conforms to an outer shape of the battery pack, is formed as a recess in a bottom surface of the charger storage portion, such that one of the charger and the battery pack can be held.

4. The power tool storage case according to claim 1, wherein retaining members that form a battery retaining portion that can hold the battery pack are detachably installed in the charger storage portion, and one of the charger and the battery pack can be held by selecting installation or removal of the retaining members.

5. The power tool storage case according to claim 4, wherein the retaining members are plate members that are provided in a standing manner on a bottom surface of the main case to form the battery retaining portion in a curving manner and that have upper edges along a whole length of which fold-back portions for reinforcement are formed in a curving manner.

6. The power tool storage case according to claim 1, wherein a presser portion is formed on an underneath surface of the lid such that, when the main case is in a closed state, the presser portion comes into contact with the battery pack that is held in the charger storage portion.

7. The power tool storage case according to claim 6, wherein the presser portion is a protrusion.

8. The power tool storage case according to claim 1, wherein the main case and the lid are hinge-jointed.

9. The power tool storage case according to claim 1, wherein the main case and the lid can be locked and unlocked by a latch.

10. The power tool storage case according to claim 1, wherein the storage portions are formed by partition panels that are arranged in a standing manner on a bottom surface of the main case.

11. The power tool storage case according to claim 5, wherein the retaining members are installed between insertion portions that are each formed by a pair of protrusions protruding in an up-down direction on inside wall surface of the charger storage portion.

12. The power tool storage case according to claim 1, wherein a small parts storage portion is formed by a partition panel that is arranged in a standing manner on a bottom surface of the main case inside the charger storage portion.
